(19) United States
(12) Patent Application Publication
(10) Pub. No.: US 2025/0252472 A1
(43) Pub. Date: Aug. 7, 2025

(54) ELECTRONIC GREETING CARD SYSTEM AND METHOD

(71) Applicant: Ink'd Greetings, Inc., Phoenix, AZ (US)

(72) Inventor: Andrew Ekmark, Phoenix, AZ (US)

(21) Appl. No.: 19/187,853

(22) Filed: Apr. 23, 2025

Related U.S. Application Data
(63) Continuation-in-part of application No. 18/916,071, filed on Oct. 15, 2024.
Application No. 18/916,071 is a continuation-in-part of application No. 18/200,519, filed on May 22, 2023.
(60) Provisional application No. 63/640,388, filed on Apr. 30, 2024.
(60) Provisional application No. 63/640,388, filed on Apr. 30, 2024.
(60) Provisional application No. 63/590,859, filed on Oct. 17, 2023.
(60) Provisional application No. 63/322,483, filed on Mar. 22, 2022.

(51) Int. Cl. G06Q 30/0601; B42D 15/02; G06Q 20/18; G07F 17/42

(52) U.S. Cl. CPC G06Q 30/0621; B42D 15/02; G06Q 20/18; G06Q 30/0643; G07F 17/42

(57) ABSTRACT

A system and method for an electronic greeting card system includes a computing device and a display responsive to the computing device with a user interface displayed on the display. The electronic greeting card system further includes a greeting card option and a gift option displayed on the user interface, so the user can associate the greeting card option with the gift option. The electronic greeting card system further includes a printer that prints the greeting card based on a user selection associated with the greeting card option the greeting card including a scannable gift code representing the gift option.

### CROSS-REFERENCE TO RELATED APPLICATIONS

This application claims the benefit of U.S. provisional patent application 63/640,388 filed Apr. 30, 2024, currently pending U.S. non-provisional patent application Ser. No. 18/200,519 filed May 22, 2023 and currently pending U.S. non-provisional patent application Ser. No. 18/916,071 filed Oct. 15, 2024.

### FIELD OF INVENTION

The present invention relates to the system and method of an electronic greeting card system that allows for customizing the greeting card and including a pre-purchased gift to be redeemed by a recipient.

### BACKGROUND

Greeting cards may be currently purchased in a variety of ways, reflecting both traditional and modern shopping habits. Greeting cards may be purchased in-store in physical retailers such as brick and mortar stores like supermarkets, drugstores, dedicated card shops (like Hallmark®), bookstores, and gift shops. A greeting card purchaser typically browses for the cards on a shelf or in an aisle. The shelves typically contain numerous iterations of greeting cards relating to anniversaries, birthdays, holidays, and the like. The greeting cards are pre-printed and chosen by the purchaser from store shelving according to the type of event or date being celebrated. The greeting cards include pre-printed illustrations and text. Since the greeting cards are mass produced, greeting card designs may be limited, and typically offer limited personalization. Greeting cards may also be purchased online from e-commerce platforms like Amazon®, Etsy®, and specialized greeting card websites that allow customers to browse a wide variety of designs and themes. There are also print-on-demand greeting cards that allow users to create custom cards that can be printed and shipped. Many of these offer personalization features, such as adding photos, custom messages, or selecting specific themes. Greeting cards may also be designed and customized using mobile apps that allow users to create, personalize, and send physical or digital cards directly from their mobile devices.

### SUMMARY

Currently, there is no single option that combines the purchase and customization of a greeting card with a pre-purchased gift. In one aspect of the subject disclosure, an electronic greeting card system is disclosed. The electronic greeting card system includes a computing device and a display responsive to the computing device with a user interface displayed on the display. The electronic greeting card system further includes a greeting card option and a gift option displayed on the user interface, so the user can associate the greeting card option with the gift option. The electronic greeting card system further includes a printer that prints the greeting card based on a user selection associated with the greeting card option. The system generates a scannable gift code for a recipient to redeem a pre-purchased gift and/or gift card based on the user selection of the gift option and the printer prints the scannable gift code on the gift card.

In some aspects, the electronic greeting card system further includes a payment processor responsive to the computing device, the payment processor processes an electronic payment from the user interacting with the user interface.

In some aspects, the user interface on the display of the electronic greeting card system receives a tactile input from the user and wherein the computing device processes the tactile input from the user.

In some aspects, the electronic greeting card system further includes a shell internally housing the computing device, the printer, and an envelope dispenser, the display is positioned on a front side of the shell and the shell includes a slot positioned to dispense the greeting card and an envelope.

In some aspects, the scannable gift code represents a pre-purchased gift.

In some aspects, the scannable gift code initiates computer readable instructions such that, when a recipient scans the scannable gift code, an application programming interface (API) is generated and electronically transmitted to a retailer, the API representing a pre-purchased gift, a name of the recipient, and an address for the recipient. An order is created by the API, wherein the order is received by the retailer and completed as an ecommerce order.

In some aspects, the computing device includes a medium storing computer readable instructions, wherein the computer readable instructions cause the computing device to send an electronic version of the greeting card to an electronic destination input by the user.

In some aspects, the gift option allows the user to select a gift from an available retailer.

In some aspects, the user interface presents to the user a delivery method option, the delivery method option includes one of pick up, direct mail, or electronic delivery.

In another instance, electronic greeting card system for a user to create a greeting card includes a computing device and a display responsive to the computing device with a user interface displayed on the display. The electronic greeting card system further includes a greeting card option and a gift option displayed on the user interface, so the user can associate the greeting card option with the gift option. The electronic greeting card system further includes an available retailer option for a user to select the gift option from to create the greeting card and a pre-purchased gift combination and a selectable link or scannable gift code printed on the greeting card for a recipient to redeem the gift option.

In some aspects, electronic greeting card system further includes a payment processor responsive to the computing device, wherein the payment processor processes an electronic payment from the user interacting with the user interface.

In some aspects, the user interface on the display receives a tactile input from the user, the computing device processes the tactile input from the user and the user interface presents to the user a delivery method option, the delivery method option includes one of pick up, direct mail, or electronic delivery.

In some aspects, the scannable gift code represents a pre-purchased gift.

In some aspects, when the user selects the gift option from the available retailer, the gift option selection is presented to the user on the customized card on the display.

In some aspects, the scannable gift code initiates computer readable instructions such that, when the recipient scans the scannable gift code, an application programming interface (API) is generated and electronically transmitted to a retailer, the API representing a pre-purchased gift, a name of the recipient, and an address for the recipient. An order is created by the API, the order is received by the retailer and completed as an ecommerce order.

In some aspects, the computing device includes a medium storing computer readable instructions, wherein the computer readable instructions instruct the computing device to send a digital version of the greeting card and gift combination electronically to an electronic destination input by the user.

In some aspects, the scannable gift code or selectable link is printed on an inside section or a back side of the greeting card.

In some aspects, the user interface presents a preview of the greeting card and a pre-purchased gift combination.

In another instance, the method for creating a greeting card and a gift combination includes selecting a greeting card option on a user interface. The method further includes selecting a recipient for the greeting card and personalizing the greeting card. The method further includes selecting a gift option to accompany the greeting card from an available retailer. The method further includes generating a scannable gift code for presentation on the greeting card so that the recipient can receive the gift option by scanning the scannable gift code on the greeting card such that an application programming interface (API) is generated and transmitted to the retailer that identifies a pre-purchased gift, a name of the recipient, and an address for the recipient and completes an ecommerce order to provide the pre-purchased gift to the recipient.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures. For simplicity and clarity of illustration, elements in the figures are not necessarily drawn to scale.

FIG. 1 is a front view of a kiosk station for generating on-demand user designed greeting cards according to a disclosed example of the subject technology;

FIG. 2 is a front perspective view of the kiosk station for generating on-demand user designed greeting cards according to a disclosed example of the subject technology;

FIG. 3 is a side perspective view showing a printer output side of the kiosk station according to a disclosed example of the subject technology;

FIG. 4 is a side view showing the printer output side of the kiosk station according to a disclosed example of the subject technology;

FIG. 5 is a front view of the kiosk station with a service door in the open position according to a disclosed example of the subject technology;

FIG. 6 is a top view of the kiosk station with the service door in the open position according to a disclosed example of the subject technology;

FIG. 7 is a perspective view of a frame of the kiosk station with an outer panel removed according to a disclosed example of the subject technology;

FIG. 8 is a block diagram of a greeting card kiosk system according to a disclosed example of the subject technology;

FIG. 9 is a flowchart of a process for generating a user-designed greeting card on site of a kiosk station according to a disclosed example of the subject technology;

FIG. 10 represents a user interface with selectable options for a type of greeting card according to a disclosed example of the subject technology;

FIG. 11 represents a user interface with selectable options for a listing of available of greeting cards in accordance with the type of greeting card according to a disclosed example of the subject technology;

FIG. 12 represents a selection confirmation user interface according to a disclosed example of the subject technology;

FIG. 13 represents a user interface allowing a user to personalize a message on the greeting card according to a disclosed example of the subject technology;

FIG. 14 represents a user interface allowing a user to select a gift card to be added to the greeting card according to a disclosed example of the subject technology;

FIG. 15 represents a user interface allowing a user to select an amount of the gift card to be added to the greeting card according to a disclosed example of the subject technology;

FIG. 16 represents a user interface allowing a user to preview the greeting card and gift card combination according to a disclosed example of the subject technology;

FIG. 17 represents a purchase summary user interface according to a disclosed example of the subject technology;

FIG. 18 represents a user interface allowing a user to select a gift to be added to the purchase;

FIG. 19 represents a user interface allowing a user to preview the greeting card and gift combination according to a disclosed example of the subject technology;

FIG. 20 represents a purchase summary user interface according to a disclosed example of the subject technology;

FIG. 21 represents a user interface allowing a user to select a delivery option for the greeting card and gift card combination according to a disclosed example of the subject technology; and

FIG. 22 represents a user interface for a payment page according to a disclosed example of the subject technology; and

FIG. 23 is a block diagram of a computing device.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

The present technology may be described in terms of functional block components and various processing steps. Such functional blocks may be realized by any number of components configured to perform the specified functions and achieve the various results. For example, the present technology may employ various types of computing devices, peripherals, and printing devices. In addition, the present technology may be practiced in conjunction with any number of devices or methods for generating personalized greeting cards from user selections, and the system described is merely one exemplary application for the technology. Methods and apparatus for a greeting card kiosk according to various aspects of the present technology may operate in conjunction with any suitable paper, printer, or other device for producing a greeting card on demand.

In general, embodiments of the subject disclosure provide an electronic greeting card system for generating personalized or customized greeting cards. In some instances the greeting card may be adapted to include a gift card and/or a pre-purchased gift. In some instances, the user may create the greeting card on site at the kiosk. In some instances, the user may create the greeting card off site via a user interface of a software application available through a mobile device, tablet, computer, or other suitable device, either online or with a mobile software application installed on a user's mobile device, tablet, computer, or other suitable device. In some instances, the greeting card designed from the remote computing device may be forwarded to a computing device resident in the kiosk and printed at the kiosk or sent electronically to an electronic destination. In some instances, the user may receive a Quick Response (QR) code or other scannable code or link when the greeting card has been designed that they can scan at the kiosk to print the greeting card. In other instances, the recipient may electronically receive a QR code or other scannable code or link when the greeting card has been designed that the recipient can scan the code or link at the kiosk to redeem and print the greeting card and schedule a delivery date for the pre-purchased gift combination. In yet other instances, the recipient may electronically receive a selectable code or link in addition to a QR code or other scannable code or link when the greeting card has been designed that the recipient may redeem electronically and schedule a delivery date for the pre-purchased gift of the greeting card and pre-purchased gift combination. In various instances, the kiosk provides a store front with a wide variety of greeting card options in a much more compact floor space. The customer may create greeting cards that appear clean (absent sloppy handwriting) and select greeting card designs that may be more compatible and personal to the recipient. In other instances, the kiosk may provide a link to various retailers that allows the user to search through a catalog of gift options to choose from in order to select and pre-purchase a gift option to send along with the greeting card to the recipient. If the user selects the gift option, data via the application programming interface's (API's) of the selected available retailer is populated and a catalog of gift options is presented to the user to select from.

A traditional greeting card is typically a folded piece of cardstock or high-quality paper, usually featuring an attractive design or artwork. Traditional greeting cards are commonly used for various occasions, including holidays (Christmas, Valentine's Day), life milestones (weddings, anniversaries), and expressions of gratitude or sympathy. They serve as a thoughtful, tangible way to convey emotions, celebrate an event, or offer support to someone special.

The greeting card may comprise a front, a back, and an inside section. The front may include an illustration, photograph, or pattern related to the occasion, such as flowers, festive decorations, or abstract designs. Greeting cards typically come in standard sizes and are paired with an envelope for that standard size. A standard size may be, for example, five inches by seven inches. In another example, a standard size may be, for example, four inches by six inches. However, a greeting card may not be limited to standard sizes.

The inside section of the greeting card may be divided into two sections. One side may contain a pre-printed message, expressing sentiments such as, but not limited to, “Happy Birthday,” “Congratulations,” “Get Well Soon,” or “Thinking of You.” The other side is often left blank, allowing space for a personal handwritten note.

A gift card may comprise a physical or digital gift card. A physical gift card is typically a small, wallet-sized card, usually made of plastic that acts as a prepaid, stored-value card for use at specific retailers or businesses. Physical gift cards typically feature the company or store's branding on the front, along with the card's value, which can be a fixed amount. The back of a physical gift card generally includes a magnetic strip or barcode for scanning during transactions, along with instructions on how to activate and use the card, terms and conditions, and sometimes a PIN for online purchases.

A digital gift card, also known as an e-gift card or electronic gift card, is a virtual version of a traditional gift card that is delivered and redeemed entirely electronically. Instead of being a physical card, it exists as a digital code, selectable link, QR code or other scannable code or link sent to the recipient via email or text message or through a mobile app. A QR code or other scannable code or link for the digital card may also be printed on the greeting card to create a greeting card gift card combination.

Additionally, a gift is often purchased along with a greeting card. Physical gifts may be purchased from a retailer online through an electronic ordering system. In some aspects, a physical gift may be purchased and sent directly from the retailer to a recipient upon completing the electronic ordering process. In other aspects, a physical gift may be pre-purchased from a retailer and delivered to the recipient at a later date upon completing the electronic ordering process and selecting a future delivery date. In yet other aspects, a physical gift may be pre-purchased from a retailer and delivered to the recipient at a date dependent upon the recipient choosing to redeem the gift.

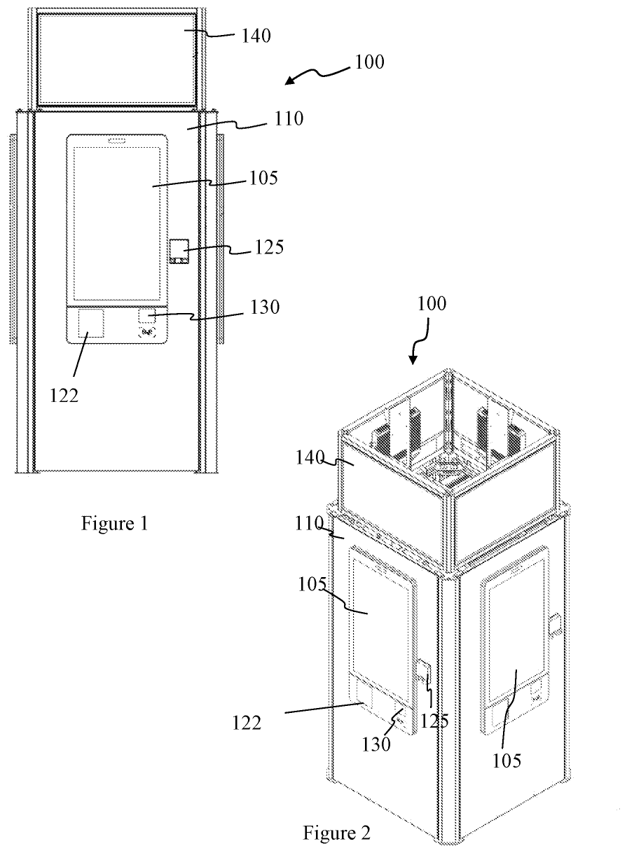

With reference to FIGS. 1-4, an example of a greeting card kiosk 100 according to one disclosed example may comprise at least one electronic display 105 for displaying a user interface (UI) for customer users to engage with to order, design, and purchase customized greeting cards. The greeting cards may be customized by the user or may be selected by the user from the available greeting cards located in the kiosk 100. A second side of the kiosk 100 may include a second display 105 to allow multiple users to simultaneously create greeting cards. In some instances, the kiosk 100 may include a shell 110 that houses the display 105 and other elements that choose a greeting card or generate a customized greeting card.

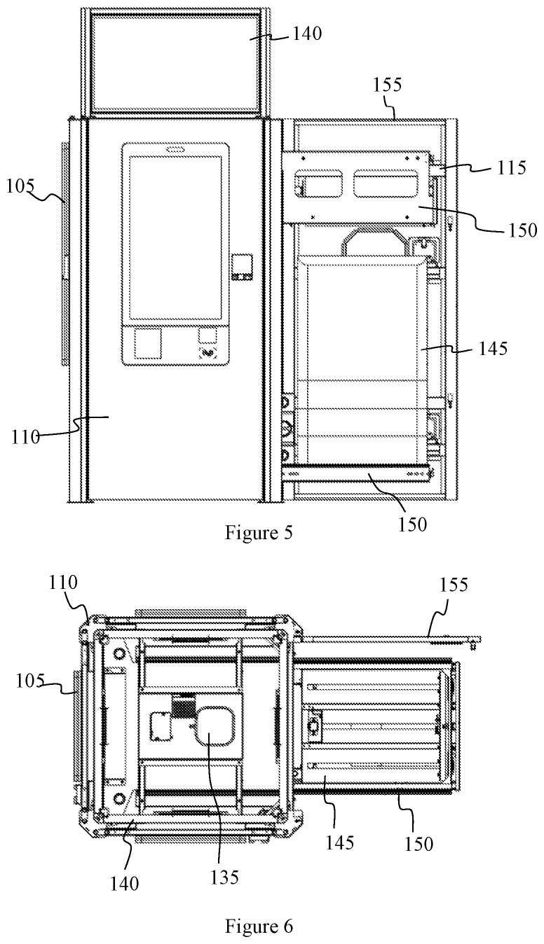

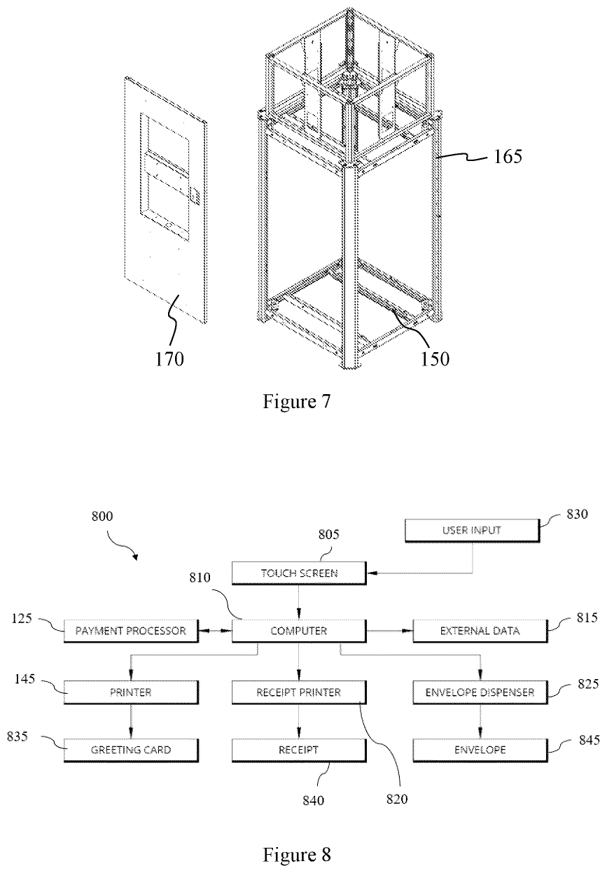

FIGS. 1-4 only show the external facing elements of the kiosk 100 and internal elements are generally hidden from view by the shell 110. Various internal elements are shown in FIGS. 5-8 In some instances, however, the shell 110 may include a window (not shown) that allows the user to watch as the greeting card is generated.

In one instances, the kiosk 100 comprises a computing device 115, shown in FIG. 5, installed within the shell 110 that coordinates the operation of multiple other elements in the kiosk 100. For example, the display 105 may comprise a touchscreen configured for tactile response to users' contact with different elements on the screen. The computing device 115 may include software to generate the UI that is shown on the display 105 and register user input selections for further processing actions that may include selecting various greeting card options, generating a ticket (concert, symphony, movie, sporting event, and the like), a coupon (store, prepaid), or generated AI content (poems, messages, photos) for printing on the greeting card, printing a greeting card, printing/loading/sending a gift card, processing payment, communicating with external parties through a network, and operating a dispenser 120 to dispense the greeting card and envelope.

In one aspect, the kiosk 100 may also comprise a scanner 122 such as for scanning a QR code or other scannable code or link received upon purchase of a greeting card gift card combination created by the computing device and displayed on a UI of a software application available through a mobile device, tablet, computer, or other suitable device, either online or with a mobile software application installed on a user's mobile device, tablet, computer, or other suitable device. The greeting card gift card combination designed from the remote computing device may be forwarded to a computing device resident in the kiosk and printed at the kiosk. In some instances, the user may receive a QR code or other scannable code or link on their mobile device, tablet, computer, or other suitable device, once the greeting card gift card combination has been designed, that they can scan with scanner 122 at the kiosk 100 when printing the greeting card gift card combination.

In another aspect, the kiosk 100 may also comprise a scanner 122 such as for scanning a QR code or other scannable code or link received upon purchase of a greeting card and pre-purchased gift combination. The code or link may be created by the computing device and displayed on the UI of a software application available through a mobile device, tablet, computer, or other suitable device either online or with a mobile device software application installed on a user's mobile device, tablet, computer, or other suitable device. The greeting card and pre-purchased gift combination designed from the remote computing device may be forwarded to a computing device resident in the kiosk where the greeting card is printed. The recipient may redeem the pre-purchased gift via the QR code or other scannable code or link. In some instances, once the greeting card and pre-purchased gift or gift card combination has been designed, the recipient may receive a QR code or other scannable code or link on their mobile device, tablet, computer, or other suitable device. The recipient can scan the QR code or other scannable code or link with scanner 122 at the kiosk 100 to print the greeting card and redeem the pre-purchased gift. The recipient may be prompted to enter their name and address on the UI and choose a delivery date for the pre-purchased gift. When the recipient scans the QR code or other scannable code or link, the UI prompts the recipient to enter the recipient's name and delivery address where an API is then sent to the retailer that includes the gift as well as the recipient's name and delivery address.

Some instances may comprise a payment processor 125 that may be separate from the display 105. The payment processor 125 may be configured to receive cash, credit/debit card, or electronic payment, such as using near-field communication (NFC). For electronic payments, the payment processor 125 may communicate through the computing device 115 with external entities to confirm the availability and transfer of funds for purchasing items through the kiosk 100. A separate printer 145 for purchase receipts may be connected to the computing device 115 and dispense receipts from a dedicated receipt slot 130. Alternatively, receipts may be dispensed from the same dispenser 120 as used for the greeting card.

The kiosk 100 may further comprise a camera (not shown) to allow the user to take a picture (e.g., selfie) and have it printed onto the greeting card selected during the design process. The computing device 115 may be configured to allow a user to upload an image that can be printed onto the greeting card. For example, the kiosk 100 may comprise a wireless internet router/antenna 135 (see FIG. 6) that allows the kiosk 100 to communicate over a wireless network such as Bluetooth, 3G, 4G, 5G, or a LAN.

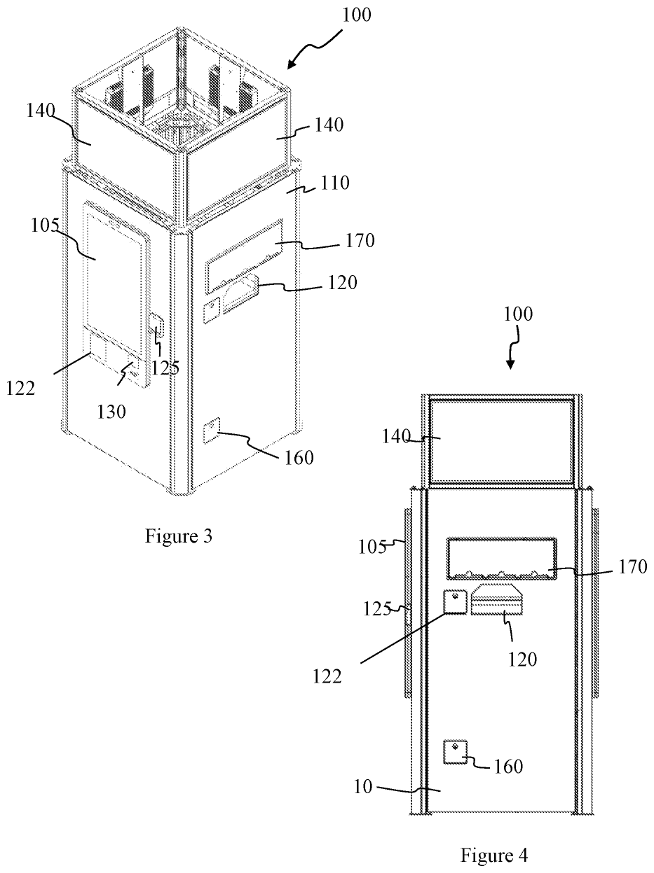

Additionally in FIGS. 1-4, the kiosk 100 may further comprise one or more surfaces dedicated to providing advertising space or related signage. In one instance, the kiosk 100 may comprise one or more screens 140 that display advertising or other information. For example, the screens 140 may comprise a video display for advertising related to the retail location where the kiosk 100 is installed. Alternatively, the screens 140 may display videos directed towards attracting customers to use the kiosk 100. The computing device 115 may also be configured to work with or be integrated into a given retail establishment's customer loyalty program or discount coupon. In this way, a given kiosk 100 may be customized according to each installed location. Additionally shown in FIGS. 3-4 is an externally accessible lock 160 to access internal components of the kiosk 100.

Referring to FIGS. 5-7, the kiosk 100 may further comprise a printer 145 installed within the shell 110 that receives greeting card formatted data from the computing device 115. The user selections are sent from the computing device 115 to the printer 145. The computing device 115 may select a card stock from a card stock repository that matches the user selection size. A picker or other card grabbing mechanism may pull the selected card stock to the printer 145 In some instances, the printer 145 may include a series of paper trays configured to hold a finite number of card stock sizes, or in other instances, a single uniform card stock size. In some instances, the card stock size may be, for example, a size sufficient for a standard-sized greeting card. The printer 145 may format the data to match the card stock or simply receive printing instructions from the computing device 115 and generate the greeting card based on the user selected input through the UI.

The card stock may include score lines so that the user can fold the printed cardstock into the proper format. The UI on the display 105 may also provide instructions to the user on how to properly fold the cardstock. In another instance, the printer 145 may be configured to fold the printed cardstock prior to dispensing the generated greeting card. In yet another instance, the computing device 115, UI on the display 105, and printer 145 may be configured to print additional items such as postcards, business cards, invitations, place cards, or other similar printed products.

Additionally in FIGS. 57, the kiosk 100 may be configured to allow for ease of maintenance. In one instance, the shell 110 may include a service door 155 that may be used to access internal components such as the printer 145, the computing device 115, communication devices, and paper supplies. Internal components may be installed on one or more racks 150 configured to increase accessibility of the internal components for maintenance. For example, racks 150 may be configured to slide in and out of an internal volume of the shell 110 when a service door 155 is open. When closed, the service door 155 may be retained in a locked position by an externally accessible lock 160 (see FIGS. 3 and 4).

The computing device 115 may also be configured to monitor and report various states of the kiosk 100. For example, the computing device 115 may be able to report ink and paper levels associated with the printer 145. At predetermined levels, a signal may be generated or sent to a selected individual so that ink or paper may be replenished prior to running empty. The computing device 115 may also report kiosk 100 status reports such as power or wi-fi outages or other system malfunctions to a central server to facilitate maintenance.

The shell 110 may be formed of a frame 165 configured to provide an attachment point for the racks 150 and one or more external panels 170. The external panels 170 may be attached to the shell 110 by any suitable method and comprise one or more openings that correspond to individual components such as the display 105 or card dispenser 120. Then frame 165 may comprise any suitable material such as metal columns or L-brackets fixed together by mechanical fasteners or welded joints.

In another instance, the kiosk 100 may be reduced in size to be more compact and take advantage of existing hardware at a given location. For example, the shell 110 may be reduced in size to eliminate the need for a dedicated printer 145. In one instance, the form factor may be reduced to the size of a tablet style computing device 115 with an online payment system. The designed greeting card may then be printed by an on-site printer 145 that is in communication with the kiosk 100.

Referring to FIG. 8, in some instances, additional elements of the kiosk 100 may reside completely within the shell 110 or may be arranged along an exterior facing surface of the shell 110. In some instances, the additional elements may include a touchscreen 805, a payment processor 125, a computer 810, external data 815, a printer 145, a receipt printer 820, an envelope dispenser 825, as well as others. The touchscreen 805 may be part of the UI of the display 105. The touchscreen 805 allows a user to interact with the UI to make selections. The touchscreen 805 may be configured to receive the user input 830 as a tactile response of the users' contact with different elements on the screen. The payment processor 125 may be an example of, or may include aspects of, the payment processor 125 of FIGS. 1-4. In some instances, the computer 810 may be an example of, or may include aspects of the computing device 115 as described in FIGS. 1-7. In one instance, the computing device 115 may be able to access a remote storage system to access additional greeting card designs or to download updated designs based on an approaching holiday or event. As described above, the computing device 115 may also be able to receive an image from the user's device, such as mobile device, computer, tablet, or other suitable device, and the like that can be printed on the selected greeting card. Additionally, in FIG. 8 the external data 815 may include, but is not limited to, additional communication devices such as fiber optic cables, an antenna, or internet router that are configured to communicate over one or more communications methods over a network with remote entities. The printer 145 may be an example of, or may include aspects of, the printer 145 of FIGS. 5-7. The printer 145 may be configured to print and dispense the greeting card 835. The printer 145 may also comprise the receipt printer 820. The receipt printer 820 may be incorporated into the printer 145 and/or may include aspects of the printer 145 of FIGS. 5-7. However, the receipt printer 820 may be configured to print a receipt 840 once the user completes the payment and the payment is received and processed by the payment processor 125. The computer 810 may send a signal to the receipt printer 820 to print a receipt of purchase for the user. The envelope dispenser 825 may be configured to dispense the envelope 845. The envelope 845 may be appropriately sized to fit the selected greeting card 835. In some instances, the envelope 845 may be configured to fit a standard sized greeting card 835. In other instances, the envelope 845 may be configured to fit a non-standard greeting card 835 size. The envelope dispenser 825 may be displaced on the external panel 170 of FIGS. 1-7.

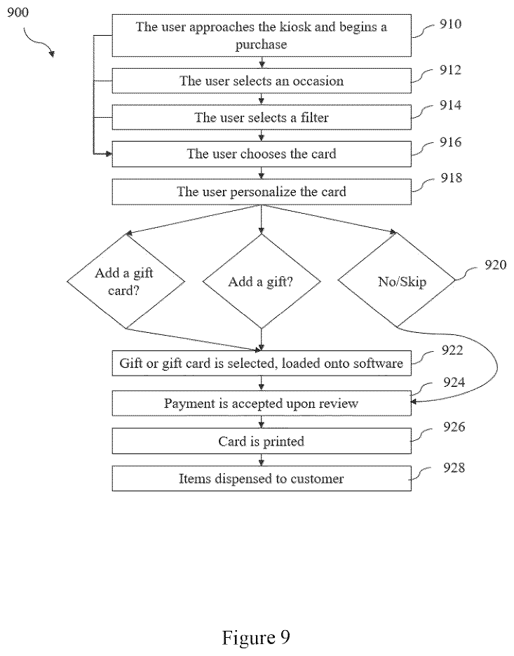

During operation, and referring now to FIG. 9, at step 910, a user may approach a kiosk station, for example, a kiosk 100 as described above with respect to FIGS. 1-7 and commence designing a greeting card for purchase. In one instance, a small selection of greeting card options may be presented on the UI at step 910. In one instance, for example, the small selection may include the most popular greeting cards. In another instance, the small selection may include one option from each occasion type. In another instance, an endless selection of greeting card options may be presented on the UI at step 910. In one instance, for example, the most popular greeting cards may appear first in the greeting card options, however a user may scroll down, or select next page, to view more greeting card options. If a user selects one of the options presented at step 910, the user may be directed to step 916 to proceed with the user selection. If the user does not select one of the options presented at step 910, but would like to view other greeting card options, the user may proceed to step 912 to view greeting card options by occasion, or step 914 to view greeting card options by a filter.

At step 912 once the user selects to begin the card creation process, the UI may present on the electronic display 105 a series of selectable options for the occasion. The occasion may comprise anniversaries, birthdays, congratulations, sympathy, thank you, and the like. The user may then select an occasion or the user may skip this step. If the user chooses not to select an occasion at step 912 the user may jump directly to step 916 where the user selects a greeting card presented on the electronic display 105 At step 914, the user may select a filter or may skip this step. If the user chooses not to select a filter at step 914, the user may jump directly to step 916 where the user selects the greeting card a greeting card presented on the electronic display 105. The filterable options may comprise a catalog of greeting card themes, graphics for insertion on the cover of card stock, graphics for insertion on the interior of cardstock, pre-defined greeting messages, a recipient's name, an electronic keyboard for receipt of user authored messages, preselected card stock sizes, and envelope sizes and colors. The greeting card themes may include filterable options for a specific occasion. In one instance, if the occasion selected is birthday, the filterable option may be, for example, birthdays for her, birthdays for him, cat lovers birthday, funny birthday, baby birthday, senior birthday, as well as others. In another instance, the filterable option for the birthday occasion may have other options. In another instance, if the occasion selected is anniversaries, the filterable options may be funny anniversary, sentimental anniversary, first anniversary, milestone anniversary, high school sweetheart anniversary, as well as others. In another instance, the filterable option for an anniversary may have other options. In yet another instance, if the occasion selected is congratulations, the filterable options may include, for example, graduation, new baby, new house, new job, as well as others. In another instance, the filterable options for congratulations may have other options.

In one instance, the graphics for insertion on the cover of the card stock may be, for example, a cake, balloons, a graduation cap, a bouquet of flowers, a heart, as well as others. Similarly, the graphics for insertion on the interior of the cardstock may be, for example,

Additionally, in one instance, if the occasion selected is birthday, a pre-defined greeting message may be, for example, “Happy Birthday! Wishing you a wonderful birthday!” or “Happy First Birthday! Hope your cake is as sweet as you, little one.” “Enjoy your special day. Have the best birthday ever, and Happy Cake Day.” In another instance, the filterable option for a pre-defined greeting message in a birthday card may have other options. In another instance, if the occasion selected is congratulations, the filterable option for a pre-defined greeting message may be, for example, “Congratulations on your High School Graduation! Best of luck on your next adventure,” or “Congratulations on your new house!” or “Congratulations on the birth of your new baby. The biggest adventure has only just begun.” In another instance, the filterable option for a pre-defined greeting message for congratulations may have other options.

In an instance, the filterable option for a preselected card stock size may be, for example, a standard greeting card size such as four inches by six inches, or five inches by seven inches, as well as others. In another instance, the filterable option for an envelope size may be, for example, sized to fit a standard greeting card. In another instance, the filterable option for an envelope color may be, for example, red, orange, yellow, green, blue, purple, pastel, as well as others.

At step 916, the user may select an available greeting card. In some instances, the greeting card selections may coincide with the small selection of popular greeting cards presented on the UI at step 910 In some instances, the greeting card selections may coincide with the optional occasion and filters of steps 912 and 914, respectively.

At step 918, the user may then select a recipient and the user may personalize the greeting card by adding a message and/or signature. The user may also have the option of using modern or classic font or handwriting the message on the electronic display 105

At step 920, after personalizing the greeting card, the UI may present the user with the option to add a gift, gift card, or none to the greeting card. If the user chose “No/Skip” at step 920, the user is directed straight to the payment process at step 924.

If the user chooses to add a gift card, the user is presented with options for the type of gift card at step 920. A “gift card” as used herein refers to a card or token that can be exchanged for a specified cash value of goods or services from a particular business or third-party store/merchant, given as a gift. If the user chooses to add a gift card, the user may be presented with various retailer options to choose a gift card from. The computing device 115 of the system may generate an API in order to present the available retailers on the display 105 for the user's selection of gift card. In some instances, the gift card options may be, for example, a gift card to Amazon, Target, Wal-Mart, as well as others. In another instance, the gift card option may be, for example, a more universally accepted gift card, such as, a VISA gift card. The UI may also ask the user the amount of the gift card they would like to provide. When the user selects a gift card option and selects an amount, an API is generated by the computing device 115 and provided to the retailer to create a purchase order with the retailer.

Additionally at step 920, a “gift” as used herein refers to a pre-purchased gift that can be delivered at a later date to the recipient upon redemption of a QR code or scannable code or link. The pre-purchased gift may be selected from a catalog of gift options from various available retailers. An “available retailer” may be but is not limited to, for example, Amazon, Wal-Mart, or Target, as well as others. Upon an affirmative input and selection type of the gift, the UI may ask the user at step 920 to select an available retailer to view the gift options from the available retailer. The computing device 115 of the system may generate an API in order to present the available retailers on the display 105 for the user's selection. When a user selects one of the available retailers, an A PI from the selected retailer is generated by the computing device 115 and data from the API is downloaded from the retailer's database and presented to the user in the form of an electronic catalog of gift options from which to select. The gift options presented to the user, may be related to the greeting card chosen in step 916. In one instance, for example, the retailer Wal-Mart may be selected. The Ul then provides the gift options from the selected retailer by pulling data of the API's from the selected available retailer for the user to search through and select the desired gift. In one instance, for example, if the retailer Wal-Mart is selected, gift options are presented to the user. The gift options may be related to the greeting card selection. For example, if the occasion “birthday” is chosen and the filter “baby birthday” is applied, the gift options may be gift options appropriate for a baby's birthday. The gift options, for example, may include toys, board books, teethers, bubbles, as well as others. In another instance, if the occasion “congratulations” is chosen and the filter “new house” is applied, the gift options may be a congratulatory gift appropriate for a housewarming present. The gift options, for example, may include a throw blanket, decorations, champagne, spice racks, cookbooks, wall décor, picture frames, kitchen accessories, as well as others. When the user selects a gift option, an API is generated by the computing device 115 and provided to the retailer to create a purchase order with the retailer.

At step 922, the UI then provides a preview of the greeting card combined with the gift card or gift for the user to review. At step 922, if a gift card is selected at step 920, once the gift card is selected and an amount is entered the gift card is loaded into the software and may be printed on the card. Additionally at step 922 if the user added a gift at step 920, the gift option selected is loaded into the software and an icon or image of the gift may be printed onto the card. In another instance, a gift code may be printed onto the greeting card at step 922 The gift code may represent the addition of either a gift or gift card. A gift code may be represented by a QR code or other scannable code or link. The gift code may be printed on the greeting card anywhere visible on the greeting card, including the front cover, inside portion, or the back, for the recipient to redeem upon receiving the greeting card and pre-purchased gift combination.

If the user chose “No/Skip” at step 920, the user is directed directly to payment at step 924. Additionally, after the gift card or gift selection is loaded into the software, a preview of the greeting card, which may include the gift code, is presented to the user on the electronic display 105 for review and payment at step 924. Additionally at step 924, the user is directed to complete the payment steps and payment is received and processed by the payment processor 125.

At step 926, the greeting card is printed. The gift code representative of either a gift or gift card, or both, may be printed anywhere visible on the greeting card, including the front cover, the inside portion, or the back. In some instances, the user may select an option of a physical greeting card or an electronic greeting card. In some instances, if a physical greeting card is selected, the computing device 115 may automatically select an envelope to match the size and/or color scheme of the card. The user selections may be stored temporarily in computing memory until a user confirms the entirety of the selections. If a physical greeting card is selected, upon completion of the user selected portion of the greeting card creation process, the computing device 115 may cause the printer 145 to receive the appropriate card stock and begin the printing process at step 926.

At step 928, the final printed card may then be dispensed from the printer 145 out of the dispenser 120 for collection by the user. An envelope may be dispensed in tandem with the greeting card through the slot 16 or through a dedicated envelope dispenser 825. The greeting card may be moved from the printer 145 and tucked under the envelope flap so that both the greeting card and envelope are dispensed simultaneously at 926. In some instances, the greeting card and envelope are dispensed one after the other.

As discussed above, some instances may include the option to include a gift card with the greeting card. Various instances may generate physical or electronic gift cards. In some instances, the gift card may be a physical gift card or an electronic gift card. If a physical gift card is selected the physical gift card will be dispensed in tandem with the greeting card at step 928 to create the greeting card gift card combination. If an electronic gift card is selected the electronic gift card may be included with the greeting card to create the greeting card gift card combination. In some instances, the gift card may be printed directly on the greeting card to create the greeting card gift card combination. In yet other instances, a gift code may be printed on the greeting cared to create the greeting card combination.

For example, during the card creation process, the software providing the UI may generate an inquiry of whether the user wishes to purchase a gift card to accompany the greeting card at step 920. On an affirmative input by the user at step 920, the computing device 115 may ask whether the user wants a digital or physical gift card. For selections of a physical gift card at step 920, the computing device 115 may access merchant information to generate a valid gift card for a specific third-party merchant. The gift card may be selected from a collection of available gift cards stored within the shell 110 or the printer 145 may be instructed at step 926 to print a physical gift card that includes the requisite information for confirming that the gift card is valid. A suitable envelope matched with the size of the gift card may be selected by the computing device 115 and dispensed to the user at step 928 in tandem with the greeting card and gift card combination. The computing device 115 may also be configured to print the address and identification information of the user and recipient of the gift card on the envelope.

For a digital selection, the computing device 115 may interface with a gift card registry for a selected merchant and cooperate with the registry to generate digital information associated with the gift card. At step 926, when the greeting card is printed, the digital gift card may be electronically sent to an account or email address or texted to a mobile device number designated by the user that will allow the recipient to access it at a later time.

At step 926, the computing device 115 may be configured to provide instructions to the printer 145 that result in the digital gift card being printed directly onto the greeting card along with the other selected options to create the greeting card gift card combination. In this way, the digital gift card is integrated into or onto the greeting card itself. The digital gift card may be integrated into part of the design of the greeting card or may simply be printed onto any suitable page or surface of the greeting card. The digital gift card may exist as a digital code or QR code or other scannable code or link printed on any suitable page or surface of the greeting card to create the greeting card gift card combination.

In other instances, a greeting card may be an electronic greeting card. If an electronic greeting card is selected, the UI may generate an inquiry asking the user to input an electronic address to which the greeting card will be sent. The electronic address may be a phone number, email address, or other electronic address type.

Additionally, during the greeting card creation process, the software providing the UI may generate an inquiry of whether the user wishes to personalize the greeting card by adding other content to the greeting card. On an affirmative input by the user, the computing device 115 may ask the user whether the user would like to add or generate a ticket, coupon, pre-selected content, or AI-generated content to the digital card or be printed on the greeting card during design of the digital card and/or the greeting card. The ticket may comprise any type of ticket, including but not limited to a ticket to a movie, concert, symphony, sporting event, comedy club, or any other event that requires a ticket. The coupon may comprise a typical store or retail coupon, or a prepaid coupon, such as Groupon, and the like. The AI-generated content may comprise a poem, text, message, photo, or any other type of user content that is generated by any suitable AI platform/generator/engine.

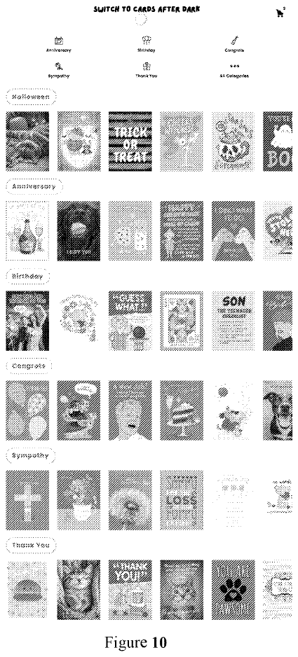

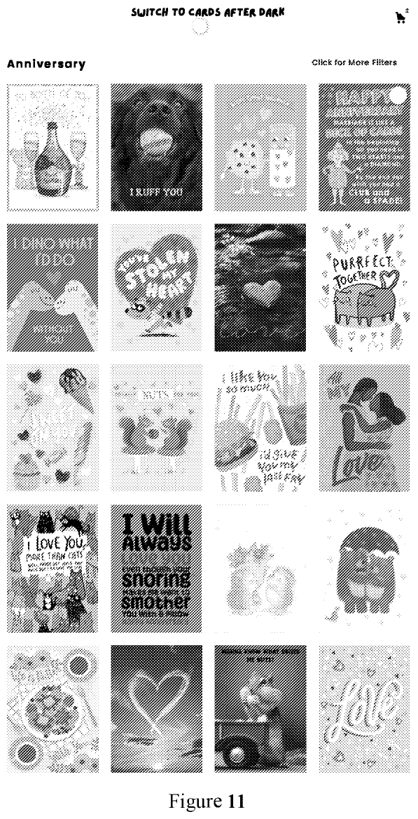

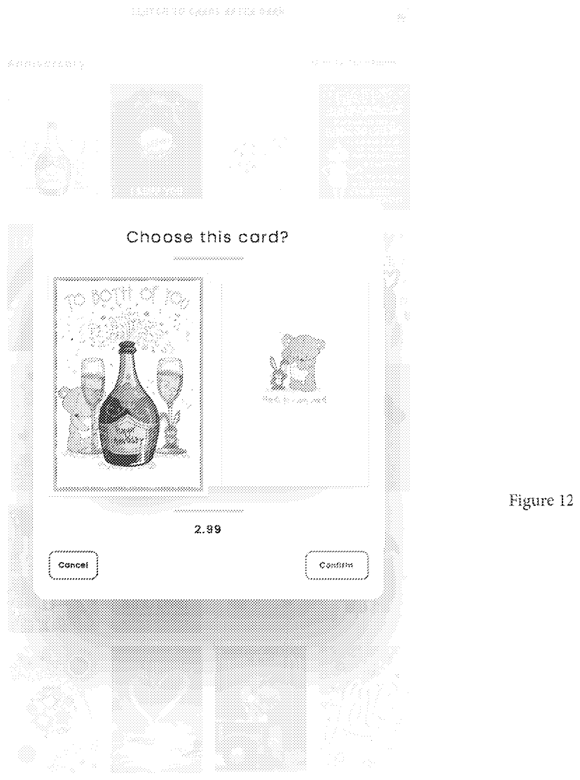

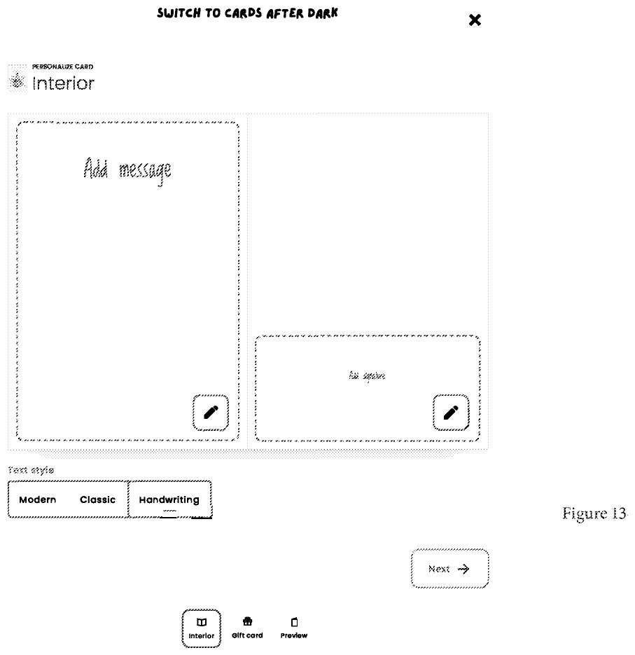

In some instances, referring now to FIGS. 10-17, a website and/or mobile device app greeting card gift card combination creation process may comprise printing the greeting card gift card combination at a kiosk 100, such as in accordance with the method described above, wherein the user may scan a QR code or other scannable code or link to print out a physical card at a kiosk 100, or the recipient may scan a QR code or other scannable code or link to print out a physical card at a kiosk 100. Alternatively, in some instances, the greeting card gift card combination or greeting card and pre-purchased gift combination may be mailed to the user or greeting card gift card combination recipient or greeting card and pre-purchased gift combination recipient. For example, a user may access the UI via a website or a mobile device app and participate in a card selection process. The user may select the option to commence designing a greeting card for purchase. Once the user selects to begin the greeting card creation process, the UI via the website or app software may present a series of selectable options such as shown in FIG. 10. The options may include the categories of what type of greeting card will be designed. Some examples include anniversaries, birthdays, congratulations, sympathy, thank you and the like. For example, a user may select the broad category of anniversary. The UI may then provide a listing of available cards for the specific Anniversary category (FIG. 11). The UI may also include a toggle of “switch to cards after dark” which allows the user to select from more adult-related content. Once the user selects a card, the UI may ask the user to confirm the selection (FIG. 12). Once the user confirms the selection, the user may then add a message and signature (FIG. 13). At this step, the user may be offered options, such as modern font, classic font, or handwriting (if their computer/app has touch capabilities), for presenting the message.

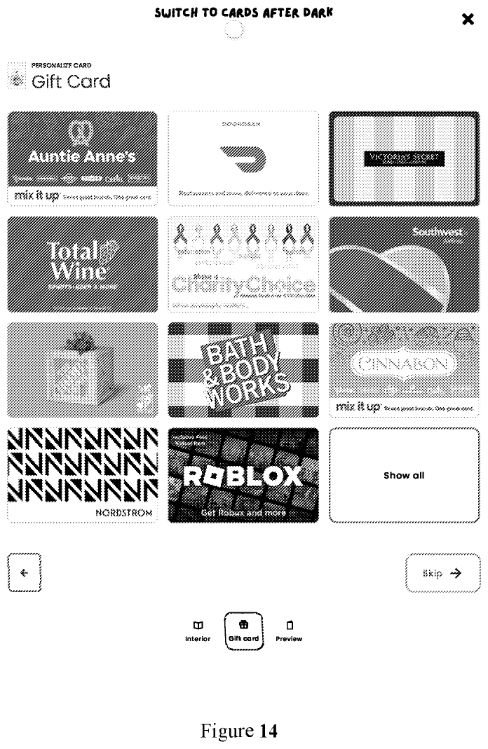

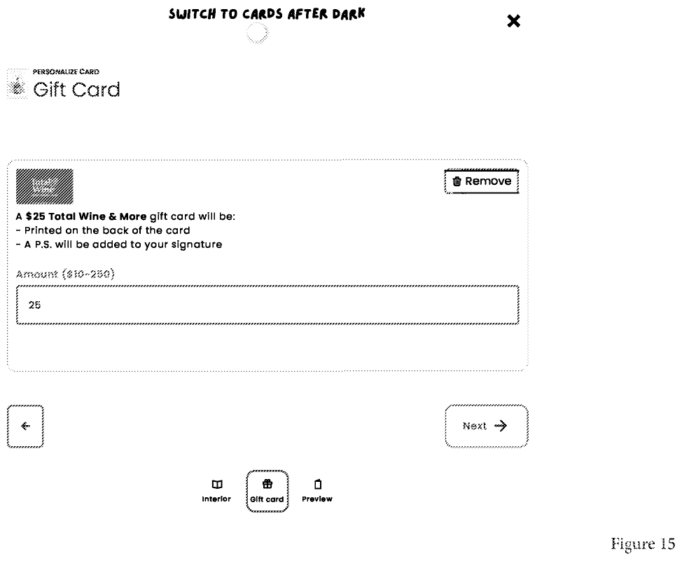

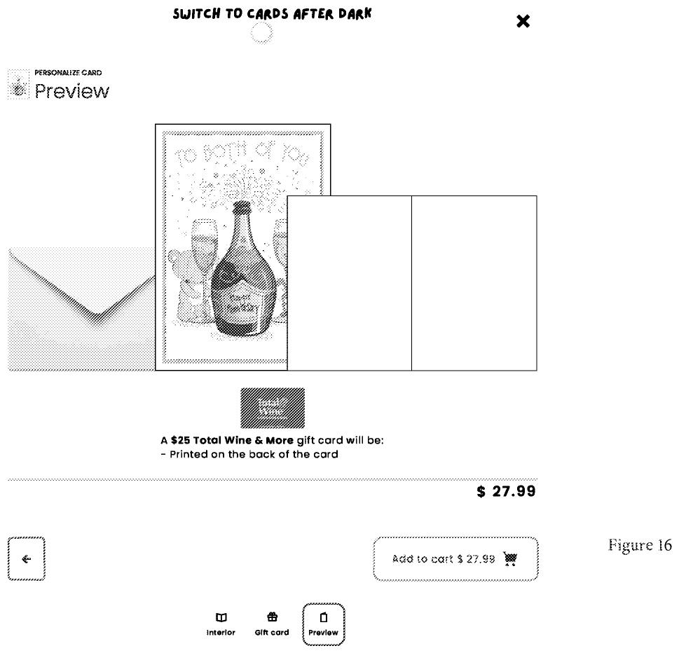

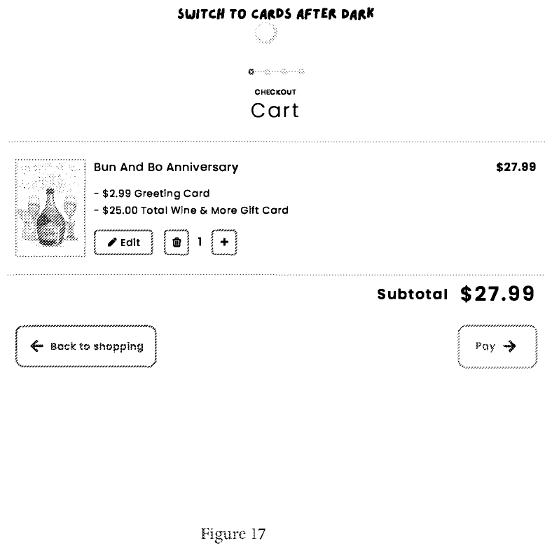

Once the user has added the message and signature, the UI may ask the user if they would like to add a gift or gift card or none (step 920) to the greeting card. If the user selects to add a gift card, the UI may ask the user to select from one of the available gift card options (FIG. 14). The gift card may be a physical gift card or a digital gift card. On an affirmative input and selection of the type of gift card, the UI may ask the user the amount of the gift card they would like to provide (FIG. 15). Upon selection of the gift card amount, the UI may provide a preview of the greeting card combined with the gift card for the user to review (FIG. 16). A physical gift card may be placed with the greeting card within the envelope when dispersed. The digital gift card may be printed on the back or any other suitable location on the greeting card. The digital gift card can be placed anywhere visible on the greeting card. Upon review, the UI directs the user to checkout and pay (FIG. 17).

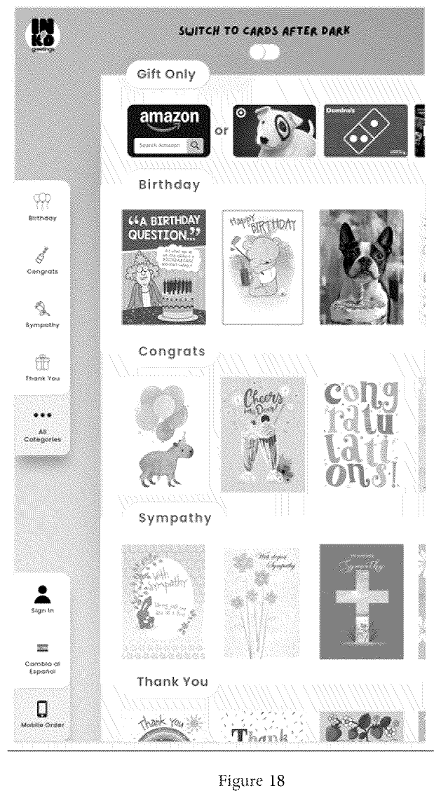

In some instances, referring now to FIGS. 18-20, a website and/or mobile device app greeting card and pre-purchased gift combination creation process may comprise printing the greeting card and pre-purchased combination at a kiosk 100, such as in accordance with the method described above, wherein the recipient may scan a QR code or other scannable code or link with scanner 122 to print out a physical card at a kiosk 100 and choose a delivery date for the pre-purchased gift. Alternatively, in some instances, the greeting card and pre-purchased gift combination may be mailed to the user or greeting card and pre-purchased gift combination recipient. For example, a user may access the UI via a website or a mobile device app and participate in a card selection process as described and shown in FIGS. 11-13. The user may select the option to commence designing a greeting card for purchase. Once the user selects to begin the greeting card creation process, the UI via the website or app software may present a series of selectable options such as shown in FIG. 11. The options may include the categories of what type of greeting card will be designed. Some examples include anniversaries, birthdays, congratulations, sympathy, thank you and the like. For example, a user may select the broad category of anniversary. The UI may then provide a listing of available cards for the specific Anniversary category (FIG. 11). The UI may also include a toggle of “switch to cards after dark” which allows the user to select from more adult-related content. Once the user selects a card, the Ul may ask the user to confirm the selection (FIG. 12). Once the user confirms the selection, the user may then add a message and signature (FIG. 13). At this step, the user may be offered options, such as modern font, classic font, or handwriting (if their computer/app has touch capabilities), for presenting the message.

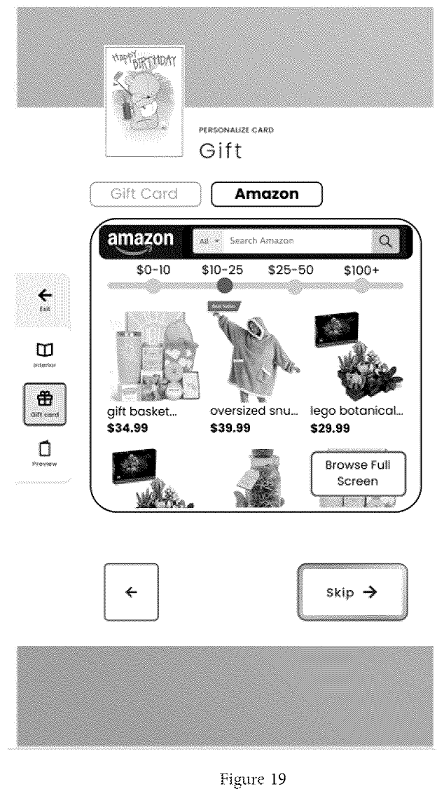

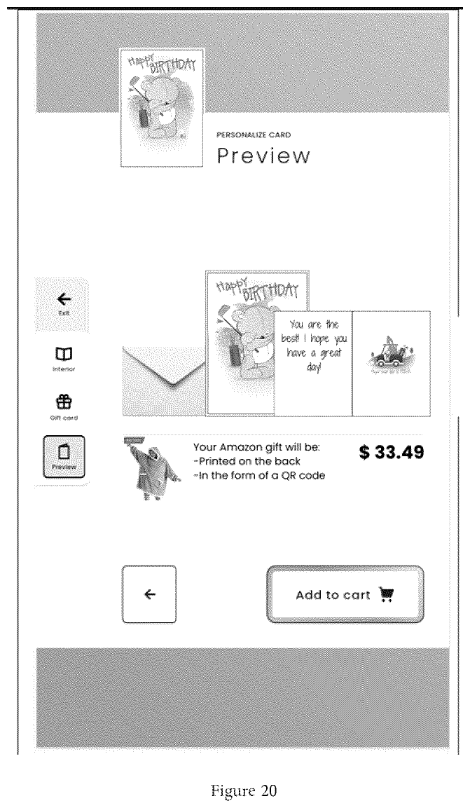

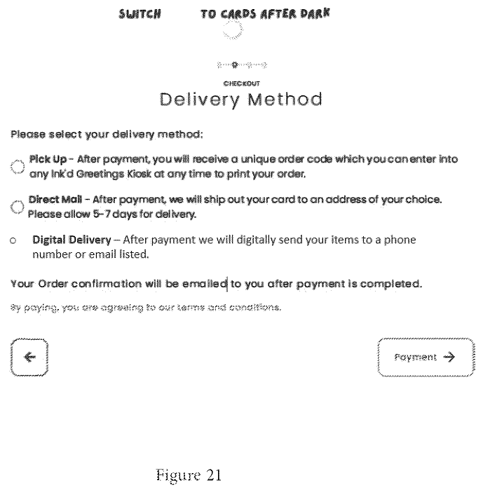

Once the user has added the message and signature, the UI may ask the user if they would like to add a gift to the greeting card (FIG. 18). The gift may be a physical gift with a QR code or other scannable code or link printed on the greeting card for the recipient to redeem upon receiving the greeting card and pre-purchased gift combination. On an affirmative input and selection of the type of gift, the UI may prompt the user the select an available retailer to search a catalog for gift options that the user would like to purchase (FIG. 19). Upon selection of the available retailer, the user searches through an electronic catalog of gift options available for purchase from that selected available retailer that are presented to the user by pulling data of the API's from the selected available retailer (FIG. 19). Upon selection of a gift option from the available retailer, the UI may provide a preview of the greeting card combined with the gift card for the user to review (FIG. 20). A QR code or other scannable code or link may be printed on the greeting card for the recipient to redeem at a later date with the QR code or other scannable code or link. The QR code or other scannable code or link may be printed on the inside, back cover or any other suitable location on the greeting card. If an electronic delivery method is selected, the recipient will receive a selectable link in addition to a QR code or scannable code or link to redeem the pre-purchased gift option. The QR code or other scannable code or link can be placed anywhere visible on the greeting card. Upon review, the UI directs the user to checkout and pay in a process similar to that shown in FIG. 17).

Upon checkout, the UI may ask the user to select the delivery method (FIG. 21). The user may then select one of the three presented options. Option 1 may be to pick up the greeting card gift card combination or greeting card and pre-purchased gift combination at the kiosk. Option 2 may be to have the greeting card gift card combination or greeting card and pre-purchased gift combination directly mailed to them or the chosen recipient. Option 3 may be to have the greeting card gift card combination or greeting card and pre-purchased gift combination delivered electronically to an electronic address of the recipient. If Option 3 is selected, the UI may prompt the user to enter a valid electronic delivery address of the recipient. The electronic address may be a phone number, email address, or other electronic address type. If the electronic delivery option is selected, the recipient will receive a selectable link in addition to a QR code or scannable code or link to redeem the pre-purchased gift option. When the recipient redeems the pre-purchased gift, the UI prompts the recipient to enter the recipient's name and delivery address where an API is sent to the retailer that includes the gift as well as the name and delivery address of the recipient.

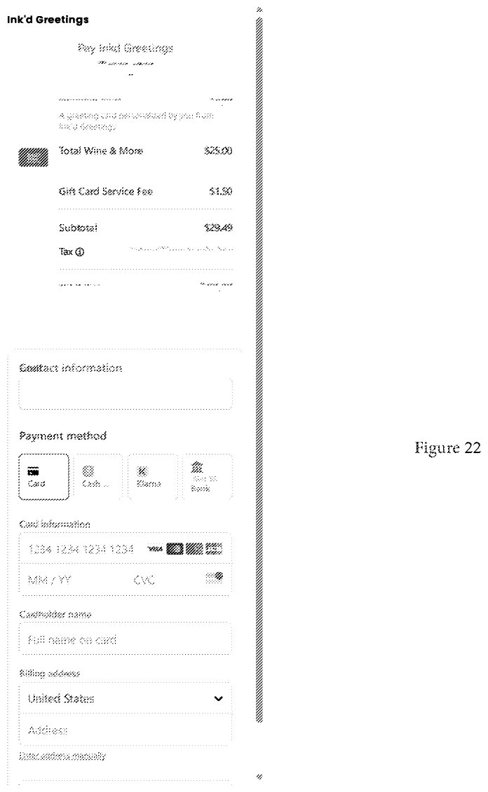

Once the delivery option has been selected, the user is directed to the payment screen (FIG. 22) to complete the purchase.

If the user selects the pick-up at kiosk 100 option, once the purchase is complete, the user will receive a digital receipt with the confirmation and order details. The user may also receive a QR code or other scannable code or link on their mobile device, tablet, or other suitable device which they could scan via scanner 122 at the kiosk 100. The user may then proceed to the kiosk 100 to retrieve their greeting card gift card combination, which would be dispensed by the kiosk 100. If the user selects electronic delivery option, the recipient will receive a digital or electronic version of the greeting card with a selectable link in addition to a QR code or scannable code or link included in the electronic greeting card to redeem the pre-purchased gift option. When the recipient chooses to redeem the pre-purchased gift, the recipient is prompted on the UI to enter their name and address where an API is sent to the retailer that includes the gift selection as well as the name and address of the recipient.

Reference to a computer system or server may be described in the general context of computer system executable instructions, such as program modules, being executed by a computer system (described for example, below). In some instances, the computer system/server may be a cloud computing node connected to a cloud computing network (not shown). The computer system/server may be practiced in distributed cloud computing environments where tasks are performed by remote processing devices that are linked through a communications network. In a distributed cloud computing environment, program modules may be located in both local and remote computer system storage media including memory storage devices.

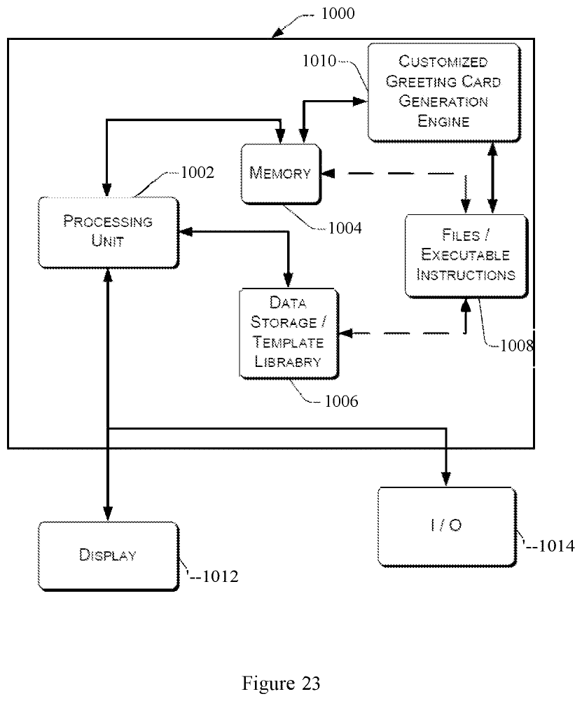

Referring now to FIG. 23, a general computing device 1000 is shown according to a disclosed example. The components of the computing device 1000 may include one or more processors or processing units 1002, a system memory 1004, storage 1006, a computer program product 1008 having a set of program modules including files and executable instructions, a customized greeting card generation engine 1010 for generating user designed greeting cards, a display 1012, I/O unit 1014, and a bus system that couples various system components including the system memory 1004 to the processor(s) 1002

The one or more processors or processing units 1002, in some instances, may be a general-purpose processor or may be part of an application-specific integrated circuit (A SIC). In other instances, the one or more processors or processing units 1002 may be a graphical processing unit (GPU), a microprocessor, a microcomputer, a processor chip, a controller, a microcontroller, a digital signal processor (DSP), a state machine, or a programmable logic device (PLD). Additionally, any processor 1002 described herein may be provided in the form of a single processor, multiple processors, or parallel processors. Multiple processors may be included in or coupled to, single device or multiple devices.

The system memory 1004 may be provided in the form of a single memory unit or multiple memory units and may be one or more articles of manufacture and/or machine components. The system memory 1004 may include static memory, dynamic memory, or both in communication. In some examples, the system memory 1004 may be one or more tangible storage mediums that can store data and executable instructions and may be non-transitory during the time instructions are stored therein. The system memory 1004 may be volatile or non-volatile, secure or encrypted, and unsecure or unencrypted.

The memory storage 1004 may store for example, user data, user selected/input greeting card data, card stock availability, and payment information. The storage 1006 may comprise a medium storing computer readable instructions, wherein the computer readable instructions cause the computing device to send a digital version of the gift card electronically to an electronic destination input by the user. The storage 1006 and template library may store files of pre-defined greeting cards, greeting card designs, and greeting card messages. The customized greeting card generation engine 1010 may include executable files that generate user customized graphics and text designs to be printed onto the card stock, which may be completely original or partially in supplement or instead of stored template elements.

In an example, the computing device 1000 may also include or be in communication with and/or operatively connected to at least one storage 1006 configured to store data. In some examples, the computing device 1000 may be in communication with the storage 1006 via the at least one bus or other communication link. The at least one storage 1006 may also store parameters associated with the greeting card options, occasion selection, filterable attributes, gift card options, gift selection options, retailers, APIs, etc.

In some examples, the I/O unit 1014 may include a system configured to manage input and output of operations for the computing device 1000, enabling efficient and seamless communication between the computing device 1000 and external systems. The I/O unit 1014 may manage input and output signals for the computing device 1000. In some cases, the I/O unit 1014 may represent a physical connection or port to an external peripheral. In some cases, the I/O unit 1014 may utilize an operating system such as iOS®, ANDROID®, MS-DOS®, MS-WINDOWS®, OS/2®, UNIX®, LINUX®, or similar operating system. Additionally, or alternatively, the I/O unit 1014 may represent or interact with a modem, a keyboard, a mouse, a joystick, a trackball, a microphone, a touchpad, a touchscreen, a display, a screen, a monitor, a speaker, or similar devices. In some cases, the I/O unit 1014 may be implemented as part of one or more processors or processing units 1002 In some cases, a user may interact with the computing device 1000 via the I/O unit 1014 or via hardware components controlled by the I/O unit 1014

In other instances, the I/O unit 1014 may include an input processing component capable of receiving, validating, and preprocessing incoming data from various sources, ensuring that the data is in a compatible format for use by the computing device 1000. Within some examples, the I/O unit 1014 may incorporate an output generation component designed to format and deliver the results (e.g., greeting card options, gift card options, or gift options, etc.) or recommendations generated by the computing device 1000 to downstream applications, interfaces, or systems based on the insights from an user input and available retailer. Additionally, the I/O unit 1014 may include a data buffering capability to temporarily store input or output data, ensuring stable and synchronized communication between the computing device 1000 and other connected systems, particularly in real-time or high-throughput environments. The I/O unit 1014 may further include error handling mechanisms to detect, report, and address any issues that arise during input or output operations, such as data inconsistencies, transmission failures, or incompatible formats. As described herein, the I/O unit 1014 may be a program, an application program interface (API), a graphical user interface (GUI), etc., that may provide interactive output to a user or another computing device 1000. For example, the I/O unit 1014 may be a GUI that is displayed to a user at a display 1012 device of the computing device 1000 The I/O unit 1014 may present information related to the greeting card options, gift options, or gift card options, and the available retailers, including information related to the greeting card selection and optional occasion selections and filterable attributes.

The components of the computing device 1000 may be interconnected and communicate via the at least one bus or other communication link. The at least one bus may enable communication via any standard or specification such as peripheral component interconnect, peripheral component interconnect express, parallel advanced technology attachment, or serial advanced technology attachment. The at least one bus may be provided in the form of a single bus or multiple buses that are operatively interconnected.

The computing device 1000 may be described in the general context of computer system executable instructions, such as the program modules which represent an exemplary software embodiment of the system and processes described generally above with respect to FIG. 9. The program modules generally carry out the functions and/or methodologies of embodiments as described above including for example, designing customized or template-based greeting cards.

The technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples. Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to an exemplary embodiment. However, changes and modifications may be made to the exemplary embodiment without departing from the scope of the present technology. These and other changes or modifications are intended to be included within the scope of the present technology. In other instances, other configurations are possible. For example, those of skill in the art will recognize, according to the principles and concepts disclosed herein, that various combinations, sub-combinations, and substitutions of the components discussed above can provide appropriate control for a variety of different configurations of greeting card kiosks for a variety of applications.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. An electronic greeting card system for a user to customize a greeting card, the system comprising:
a computing device;
a display responsive to the computing device with a user interface displayed on the display;
a greeting card option and a gift option displayed on the user interface, so the user can associate the greeting card option with the gift option; and
a printer that prints the greeting card based on a user selection associated with the greeting card option, the greeting card including a scannable gift code representing the gift option.

2. The electronic greeting card system of claim 1, further comprising a payment processor responsive to the computing device, wherein the payment processor processes an electronic payment from the user interacting with the user interface.

3. The electronic greeting card system of claim 1, wherein the user interface on the display receives a tactile input from the user and wherein the computing device processes the tactile input from the user.

4. The electronic greeting card system of claim 1, further comprising a shell internally housing the computing device, the printer, and an envelope dispenser, the shell includes a slot positioned to dispense the greeting card and an envelope, wherein the display is positioned on a front side of the shell.

5. The electronic greeting card system of claim 1, wherein the scannable gift code represents a pre-purchased gift.

6. The electronic greeting card system of claim 1, wherein the scannable gift code initiates computer readable instructions such that, when a recipient scans the scannable gift code, an application programming interface (API) is generated and electronically transmitted to a retailer, the API representing a pre-purchased gift, a name of the recipient, and an address for the recipient; and
an order is created by the API, wherein the order is received by the retailer and completed as an ecommerce order.

7. The electronic greeting card system of claim 6, wherein the computing device includes a medium storing computer readable instructions, wherein the computer readable instructions cause the computing device to send an electronic version of the greeting card to an electronic destination input by the user.

8. The electronic greeting card system of claim 1, wherein the gift option allows the user to select a gift from an available retailer.

9. The electronic greeting card system of claim 1, wherein the user interface presents to the user a delivery method option, the delivery method option includes one of pick up, direct mail, or electronic delivery.

10. An electronic greeting card system for a user to create a greeting card, the system comprising:
a computing device;
a display responsive to the computing device with a user interface displayed on the display;
a greeting card option and a gift option displayed on the user interface, so the user can associate the greeting card option with the gift option; and
an available retailer option for a user to select the gift option from to create the greeting card and a pre-purchased gift combination; and
a selectable link or scannable gift code printed on the greeting card for a recipient to redeem the gift option.

11. The electronic greeting card system of claim 10, further comprising a payment processor responsive to the computing device, wherein the payment processor processes an electronic payment from the user interacting with the user interface.

12. The electronic greeting card system of claim 10, wherein the user interface on the display receives a tactile input from the user, further wherein the computing device processes the tactile input from the user.

13. The electronic greeting card system of claim 10, wherein the user interface presents to the user a delivery method option, the delivery method option includes one of pick up, direct mail, or electronic delivery.

14. The electronic greeting card system of claim 10, wherein the scannable gift code represents a pre-purchased gift.

15. The electronic greeting card system of claim 10, wherein when the user selects the gift option from the available retailer, the gift option selection is presented to the user on the customized card on the display.

16. The electronic greeting card system of claim 10, wherein the scannable gift code initiates computer readable instructions such that, when the recipient scans the scannable gift code, an application programming interface (API) is generated and electronically transmitted to a retailer, the API representing a pre-purchased gift, a name of the recipient, and an address for the recipient; and
an order is created by the API, wherein the order is received by the retailer and completed as an ecommerce order.

17. The electronic greeting card system of claim 16, wherein the computing device includes a medium storing computer readable instructions, wherein the computer readable instructions instruct the computing device to send a digital version of the greeting card and pre-purchased gift combination electronically to an electronic destination input by the user.

18. The electronic greeting card system of claim 10, wherein the scannable gift code or selectable link is printed on an inside section or a back side of the greeting card.

19. The electronic greeting card system of claim 10, wherein the user interface presents a preview of the greeting card and a pre-purchased gift combination.

20. A method for creating a greeting card and a gift combination, the method comprising:
selecting a greeting card option on a user interface;
selecting a recipient for the greeting card;
personalizing the greeting card;
selecting a gift option to accompany the greeting card from an available retailer, and
generating a scannable gift code for presentation on the greeting card so that the recipient can receive the gift option by scanning the scannable gift code on the greeting card such that an application programming interface (API) is generated and transmitted to the retailer that identifies a pre-purchased gift, a name of the recipient, and an address for the recipient and completes an ecommerce order to provide the pre-purchased gift to the recipient.
